(19) United States
(12) Patent Application Publication
(10) Pub. No.: US 2021/0011832 A1
(43) Pub. Date: Jan. 14, 2021

(54) LOG ANALYSIS SYSTEM, LOG ANALYSIS METHOD, AND STORAGE MEDIUM

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 17/040,742

(22) PCT Filed: Apr. 19, 2018
(86) PCT No.: PCT/JP2018/016189

§ 371 Date: Sep. 23, 2020

(51) Int. Cl. G06F 11/34; G06F 16/901; G06K 9/62

(52) U.S. Cl. CPC G06F 11/3476; G06K 9/6215; G06F 16/901

(57) ABSTRACT

Provided are a log analysis system, a log analysis method, and a storage medium that can generate information indicating a state of a system without requiring to manually define a state of the target system in advance. The log analysis system includes: a feature extraction unit that extracts at least one feature of a text log file including a plurality of text log messages corresponding to information in which an event in a target system and a time when the event occurred are associated with each other; and an index generation unit that, based on the feature and numerical data including numerical information related to the target system and a time when the numerical information was stored, generates an index indicating a state of the target system.

### TECHNICAL FIELD

The present invention relates to a log analysis system, a log analysis method, and a storage medium.

### BACKGROUND ART

Patent Literature 1 discloses a searching technique that relates to a user operation performed on a user terminal such as collection of an operation log of the user operation performed on the user terminal and extraction of a specific operation from the operation log. When the user terminal generates a feature amount from the operation log generated in the user terminal and the feature amount satisfies a predetermined condition, the information processing system disclosed in Patent Literature 1 transmits the operation log and the feature amount to an information analysis apparatus. The information analysis apparatus searches for the operation log based on the feature amount when the information analysis apparatus receives a searching request related to the operation log.

Patent Literature 2 discloses a detection rule generation apparatus that generates a detection rule of an event in a system including a plurality of components. The apparatus disclosed in Patent Literature 2 identifies a candidate event that is a candidate to be selected for generating a detection rule based on system configuration information on the system and history information on the system.

### CITATION LIST

### Patent Literature

PTL 1: Japanese Patent No. 5677592

PTL 2: Japanese Patent No. 5274565

### SUMMARY OF INVENTION

### Technical Problem

The techniques disclosed in Patent Literatures 1 and 2 are techniques intended to generate a feature amount indicating a state of a known system by using a part of a text log output from the system or a detection rule. Thus, the state of a system to be analyzed is required to be manually defined in advance.

One of the objects of the present invention is to provide a log analysis system, a log analysis method, and a storage medium that can generate information indicating the state of a system without requiring to manually define a state of a target system in advance.

### Solution to Problem

The first example aspect of the present invention is a log analysis system including: a feature extraction unit that extracts at least one feature of a text log file including a plurality of text log messages corresponding to information in which an event in a target system and a time when the event occurred are associated with each other; and an index generation unit that, based on the feature and numerical data including numerical information related to the target system and a time when the numerical information was stored, generates an index indicating a state of the target system.

The second example aspect of the present invention is a log analysis method including: extracting at least one feature of a text log file including a plurality of text log messages corresponding to information in which an event in a target system and a time when the event occurred are associated with each other; and based on the feature and numerical data including numerical information related to the target system and a time when the numerical information was stored, generating an index indicating a state of the target system.

The third example aspect of the present invention is a storage medium storing a program that causes a computer to perform: extracting at least one feature of a text log file including a plurality of text log messages corresponding to information in which an event in a target system and a time when the event occurred are associated with each other; and based on the feature and numerical data including numerical information related to the target system and a time when the numerical information was stored, generating an index indicating a state of the target system.

### Advantageous Effects of Invention

According to the present invention, it is possible to generate the information indicating a system state without requiring to manually define a state of a target system in advance.

### BRIEF DESCRIPTION OF DRAWINGS

FIG. 1 is a block diagram illustrating a configuration of a log analysis system according to a first example embodiment of the present invention.

FIG. 2A is a diagram illustrating an example of a log file loaded by the log analysis system according to the first example embodiment of the present invention.

FIG. 2B is a diagram illustrating an example of a numerical data file loaded by the log analysis system according to the first example embodiment of the present invention.

FIG. 3 is a diagram illustrating an example of a log format of a log file loaded by the log analysis system according to the first example embodiment of the present invention.

FIG. 4 is a diagram illustrating an example of feature information extracted by the log analysis system according to the first example embodiment of the present invention.

FIG. 5 is a diagram illustrating an example of index information generated by the log analysis system according to the first example embodiment of the present invention.

FIG. 6 is a diagram illustrating an example of output of the log analysis system according to the first example embodiment of the present invention.

FIG. 7 is a block diagram illustrating an example of a hardware configuration of the log analysis system according to the first example embodiment of the present invention.

FIG. 8 is a flowchart illustrating an operation related to generation of indexes of the log analysis system according to the first example embodiment of the present invention.

FIG. 9 is a flowchart illustrating an operation related to matching of indexes of the log analysis system according to the first example embodiment of the present invention.

FIG. 10 is a block diagram illustrating a configuration of a log analysis system according to a second example embodiment of the present invention.

FIG. 11 is a diagram illustrating an example of the system state stored by the log analysis system according to the second example embodiment of the present invention.

FIG. 12 is a diagram illustrating an example of output of the log analysis system according to the second example embodiment of the present invention.

FIG. 13 is a block diagram illustrating a configuration of a log analysis system according to a third example embodiment of the present invention.

FIG. 14 is a diagram illustrating an example of feature information extracted by the log analysis system according to the third example embodiment of the present invention.

FIG. 15 is a block diagram illustrating a configuration of a log analysis system according to a fourth example embodiment of the present invention.

FIG. 16 is a block diagram illustrating a configuration of a log analysis system according to another example embodiment of the present invention.

### DESCRIPTION OF EMBODIMENTS

### First Example Embodiment

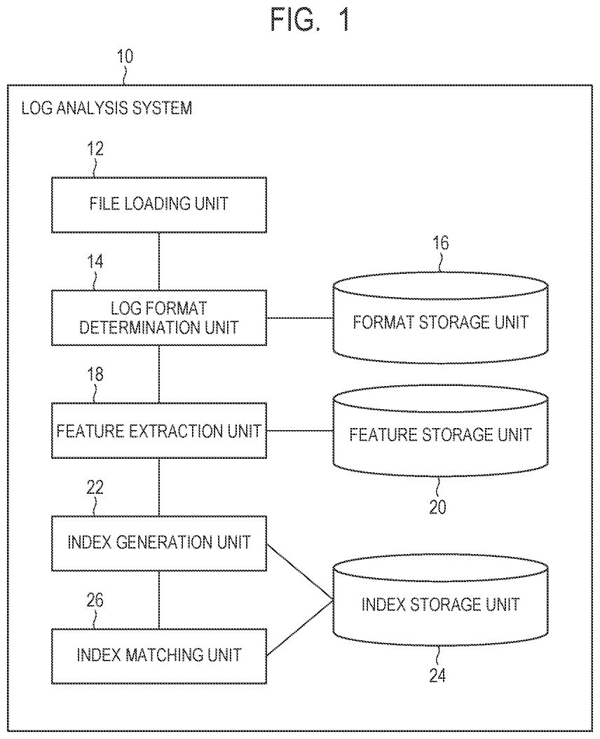

A log analysis system and a log analysis method according to a first example embodiment of the present invention will be described with reference to FIG. 1 to FIG. 9.

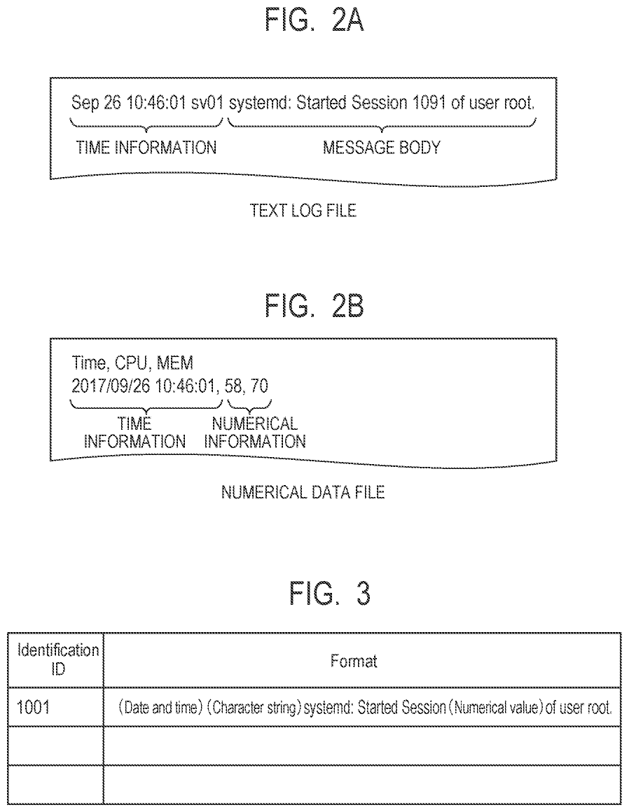

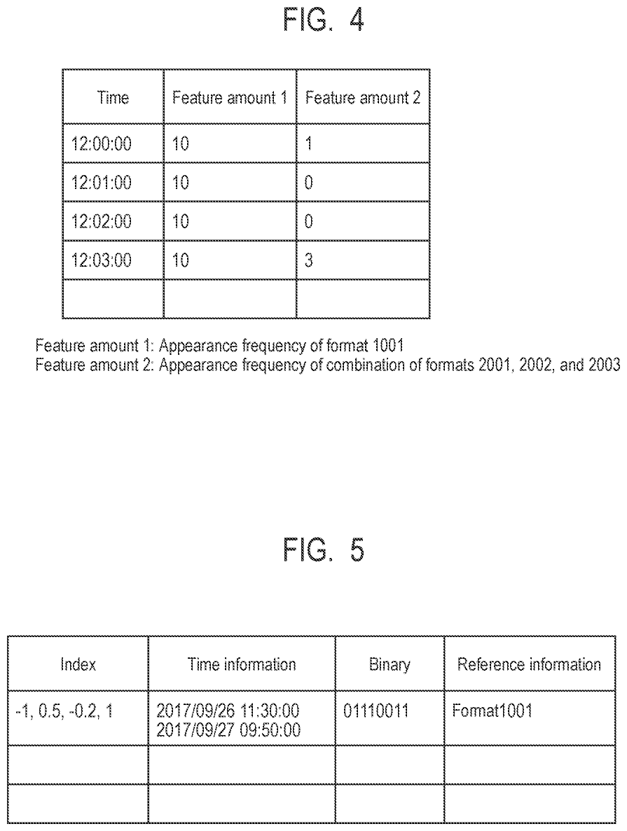

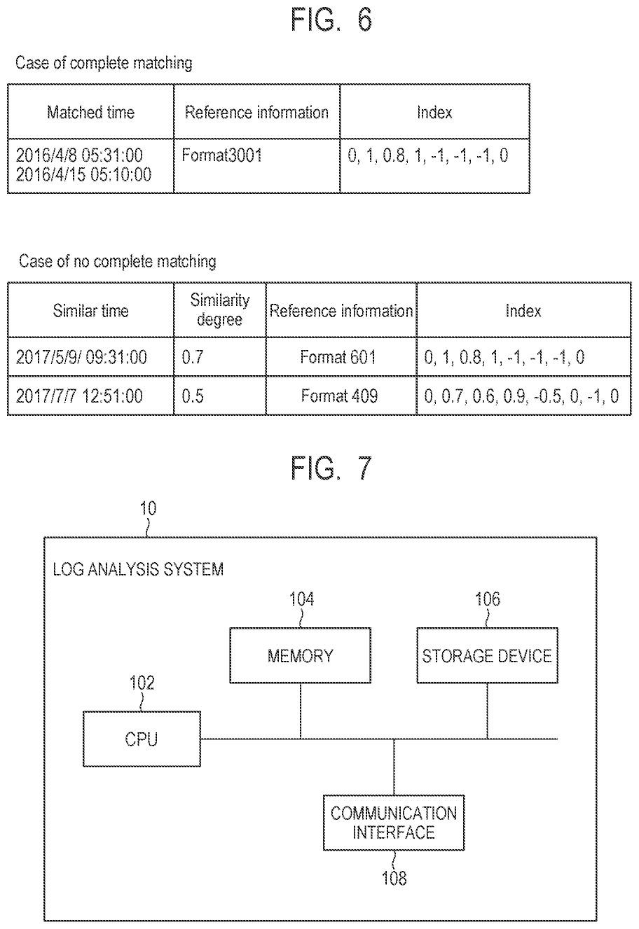

First, the configuration of the log analysis system according to the present example embodiment will be described with reference to FIG. 1 to FIG. 7. FIG. 1 is a block diagram illustrating the configuration of the log analysis system according to the present example embodiment. FIG. 2A and FIG. 2B are diagrams illustrating an example of a log file and an example of a numerical data file loaded by the log analysis system according to the present example embodiment, respectively. FIG. 3 is a diagram illustrating an example of a log format of the log file loaded by the log analysis system according to the present example embodiment. FIG. 4 is a diagram illustrating an example of feature information extracted by the log analysis system according to the present example embodiment. FIG. 5 is a diagram illustrating an example of index information generated by the log analysis system according to the present example embodiment. FIG. 6 is a diagram illustrating an example of output of the log analysis system according to the present example embodiment. FIG. 7 is a block diagram illustrating an example of a hardware configuration of the log analysis system according to the present example embodiment.

In operation and maintenance of an information processing system, a person who performs operation and maintenance (hereinafter, described as “administrator”) analyzes a log such as a numerical value or a text output from the information processing system and determines the state of the information processing system. Conventionally, in analysis of a log, the administrator generates a rule used for analyzing the log. However, as a result of a significant increase in the size of the log output from the information processing system, it is difficult for the administrator to define a rule used for exhaustively analyzing the log. Thus, there is a demand for a technique for supporting the analysis of the log output from the information processing system.

On the other hand, the log analysis system according to the present example embodiment acquires a log file output from a target system such as an information processing system and analyzes a log included in the log file. For example, the information processing system is formed of an apparatus such as a server, a client terminal, a network apparatus, or other information apparatuses or software such as system software or application software that operates on the apparatus. Note that the log analysis system according to the present example embodiment can target and analyze a log output from any target systems in addition to the information processing system.

A text log file (hereinafter, referred to as “log file” where appropriate) is formed of a plurality of text log messages (hereinafter, referred to as “log message” where appropriate). In other words, the log file is a set of a plurality of log messages. The log message is also referred to as a log record. The log message is information in which an event in the target system and a time when the event occurs are associated with each other. More specifically, the log message is formed of a plurality of log elements such as a time when a message of interest is output, a log identification (ID) that is an identifier that can uniquely identify a message of interest, a message body, or a log level, for example.

FIG. 2A illustrates an example of a log file and a log message. The log message forming a log file is formed of time information indicating a time such as date and time and a message body indicating a meaning of the log message. For example, the time information is formed of a combination of a date including year/month/day, month/day, or the like and a time including hour/minute/second, hour/minute, or the like or any one of date and time. The log message is expressed by characters and can be divided into a word unit having a meaning with an arbitrary symbol such as a space, a dot, a slash, or the like.

FIG. 2B illustrates an example of a numerical data file and numerical data. The numerical data forming the numerical data file is formed of at least one piece of numerical information related to a target system and time information related to a time when the numerical information is stored. The numerical data includes a time related to the target system and the numerical information stored at the corresponding time. The example illustrated in FIG. 2B indicates that the numerical data includes two types of numerical information, namely, numerical information corresponding to “CPU” related to a central processing unit (CPU) and numerical information corresponding to “MEM” related to a memory in addition to time information corresponding to “Time”.

As illustrated in FIG. 1, the log analysis system 10 according to the present example embodiment has a file loading unit 12, a log format determination unit 14, and a format storage unit 16. The log analysis system 10 according to the present example embodiment further has a feature extraction unit 18, a feature storage unit 20, an index generation unit 22, an index storage unit 24, and an index matching unit 26.

The file loading unit 12 loads a log file to be analyzed output from the target system. The file loading unit 12 may directly receive and load the log file from a system that is an analysis target. Alternatively, the file loading unit 12 may read and load the log file from a storage unit (not illustrated). Alternatively, the file loading unit 12 may accept input of a log file from the administrator and load the log file.

For example, the file loading unit 12 may accept, from the administrator, designation of a range of a loading log such as designation of the log file to be loaded or designation of date and time or a range of time the log is loaded. Alternatively, the file loading unit 12 may convert a form of the loaded log file into a form that may be easily analyzed by the log analysis system 10. In such a case, the file loading unit 12 can load a file (not illustrated) in which information required for log analysis is defined and convert a form of the log file in accordance with the information defined by the file, for example.

The file loading unit 12 further loads the numerical data file output from the target system that outputs the log file. The file loading unit 12 may directly receive and load a numerical data file from the system that is an analysis target. Alternatively, the file loading unit 12 may read and load a numerical data file from a storage unit (not illustrated). Alternatively, the file loading unit 12 may accept input of a numerical data file from the administrator and load the numerical data file.

The format storage unit 16 stores format information. The format information is information that defines the structure of a log message. FIG. 3 illustrates an example of the format information. The format information includes one or more format records formed of at least an identification ID and a format. The identification ID is a symbol uniquely defined in order to identify the format record. The format corresponds to a rule for normalizing the structure of the log message.

In the example of format information illustrated in FIG. 3, a format corresponding to a rule for organizing the log message illustrated in FIG. 2A is expressed by a character string for simplification. In the format illustrated in FIG. 3, the expression “(date and time)” means that a character string indicating date and time is placed in the corresponding position of the log message. Further, the expression “(character string)” means that some character strings are placed in the corresponding position of the log message. Further, the expression “(numerical value)” means that numerical information is placed in the corresponding position of the log message. The format may be defined in a form of a regular expression that can be processed by a calculator.

The log format determination unit 14 determines the structure of the log message included in the log file, that is, a log form that is a format of the log message. The log format determination unit 14 compares format information stored in the format storage unit 16 with the input log message. As a result of comparison, when there is format information that matches the log message, the log format determination unit 14 normalizes the log message in accordance with the format information based on the format information. On the other hand, when there is no matched format information, the log format determination unit 14 extracts a set of log messages that do not match the existing format information out of the input log files and generates new format information from the extracted set of log messages. The log format determination unit 14 causes the format storage unit 16 to store the new generated format information.

The feature extraction unit 18 extracts feature information including a plurality of feature amounts from the input log file and the input numerical data file as the feature thereof. The details of the feature extraction unit 18 will be described later.

The feature storage unit 20 stores feature information including the plurality of feature amounts extracted by the feature extraction unit 18. FIG. 4 illustrates an example of feature information. As illustrated in FIG. 4, the feature information is formed of time information and a feature record having information related to at least one or more feature amounts. In the example illustrated in FIG. 4, two feature amounts 1 and 2 are illustrated as the feature amount. The feature amount 1 corresponds to an appearance frequency of the log message corresponding to a format 1001. The feature amount 2 corresponds to an appearance frequency of a combination of log messages corresponding to a format 2001, a format 2002, and a format 2003. Further, each of the feature amounts 1 and 2 at the time of interest is expressed by a numerical value. For example, at a time “12:00:00”, it is indicated that “10” log messages corresponding to the format 1001 are output. Further, at the same time “12:00:00”, it is indicated that “1” log message corresponding to the format 2001, “1” log message corresponding to the format 2002, and “1” log message corresponding to the format 2003 are output.

The index generation unit 22 generates an index based on a feature of the log file and the numerical data including a time related to the target system and numerical information stored at the time. The index corresponds to information indicating feature of input data in an arbitrary time section. That is, the index corresponds to information indicating state of the target system in an arbitrary time section. The details of the index generation unit 22 will be described later.

The index storage unit 24 stores index information including an index generated by the index generation unit 22. FIG. 5 illustrates an example of index information. The index information is formed of one or more index information records including at least the index and time information. Further, the index information record illustrated in FIG. 5 as an example includes a binary code and reference information in addition to the information described above. The index corresponds to information expressing the state of a system expressed by a combination of a plurality of numerical values. The time information has one or more times the index described above appears. The binary code is a value into which the index is converted in order to improve efficiency of the search. The reference information is information such as a feature amount and the log message that are included in the index used for interpreting the index by the administrator or a user, for example.

The index matching unit 26 compares the index information for search generated from a text and numerical data that are newly input for searching with the known index information stored in the index storage unit 24. When there is known index information that completely matches the index information for search, the index matching unit 26 outputs related information such as an index included in the index information or a time. When there is no completely matching index information, the index matching unit 26 outputs similar known index information together with a similarity degree. The details of the index matching unit 26 will be described later.

FIG. 6 illustrates examples of output of the index matching unit 26 when there is a complete matching, and there is no complete matching. As illustrated in FIG. 6, in the case of a complete matching, the index included in the matched known index information, time, and reference information are output. On the other hand, in the case of no complete matching, the index included in the similar known index information, time, and reference information are output together with a similarity degree. The similarity degree indicates a degree to which the known index information and the index information for search are similar.

The log analysis system 10 according to the present example embodiment described above can be formed of a computer apparatus. FIG. 7 illustrates an example of a hardware configuration of the log analysis system 10 according to the present example embodiment.

As illustrated in FIG. 7, the log analysis system 10 has a central processing unit (CPU) 102, a memory 104, a storage device 106, and a communication interface 108. The log analysis system 10 may have an input device, an output device, or the like (not illustrated). Note that the log analysis system 10 may be formed as an independent apparatus or may be formed integrally with another apparatus.

The communication interface 108 is a communication unit that transmits and receives data and is configured to be able to execute at least one of the communication schemes of wired communication and wireless communication. The communication interface 108 includes a processor, an electric circuit, an antenna, a connection terminal, or the like required for the above communication scheme. The communication interface 108 is connected to a network and performs communication by using the communication scheme in accordance with a signal from the CPU 102. The communication interface 108 receives the log file and the numerical data file to be analyzed from the external system, for example.

The storage device 106 stores a program executed by the log analysis system 10, data of a process result obtained by the program, or the like. The storage device 106 includes a read only memory (ROM) dedicated to reading, a hard disk drive or a flash memory that is readable and writable, or the like. Further, the storage device 106 may include a computer readable portable storage medium such as a compact disc read only memory (CD-ROM). The memory 104 includes a random access memory (RAM) or the like that temporarily stores data being processed by the CPU 102 or a program and data read from the storage device 106.

The CPU 102 is a processor as a processing unit that temporarily stores temporary data used for processing in the memory 104, reads a program stored in the storage device 106, and performs various processes such as calculation, control, determination, or the like on the temporary data in accordance with the program. Further, the CPU 102 stores data of a process result in the storage device 106 and also transmits data of the process result externally via the communication interface 108.

The CPU 102 functions as the file loading unit 12, the log format determination unit 14, the feature extraction unit 18, the index generation unit 22, and the index matching unit 26 illustrated in FIG. 1 by executing the program stored in the storage device 106. In operation, the CPU 102 controls the communication interface 108, the input device, and the output device as appropriate.

Further, the storage device 106 functions as the format storage unit 16, the feature storage unit 20, and the index storage unit 24 illustrated in FIG. 1.

The communication performed by the log analysis system 10 is implemented when an application program controls the communication interface 108 by using a function provided by operating system (OS), for example. The input device is a keyboard, a mouse, or a touch panel, for example. The output device is a display, for example. The log analysis system 10 is not limited to a single apparatus and may be configured such that two or more physically separate apparatuses are connected so as to be able to communicate by wired or wireless connection. Further, respective units included in the log analysis system 10 may be implemented by an electric circuitry, respectively. The electric circuitry here is a term conceptually including a single device, multiple devices, a chipset, or a cloud. Note that the hardware configurations of the log analysis system 10 and each function block thereof are not limited to the configurations described above. Further, the hardware configuration described above can be applied to a log analysis system according to another example embodiment described later.

Note that the log analysis systems illustrated in the present example embodiment and in each example embodiment described later as examples are also formed of a nonvolatile storage medium such as a compact disc in which a program that implements the above functions is stored. The program stored in the storage medium is read by a drive device, for example.

Further, at least a part of the log analysis system 10 may be provided in a form of Software as a Service (SaaS). That is, at least some of the functions for implementing the log analysis system 10 may be executed by software executed via a network.

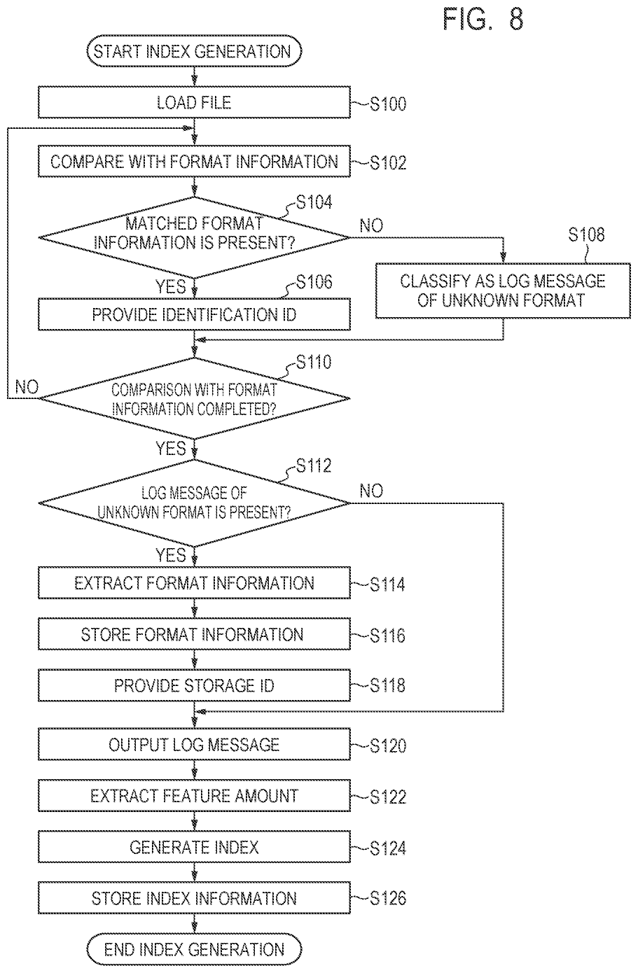

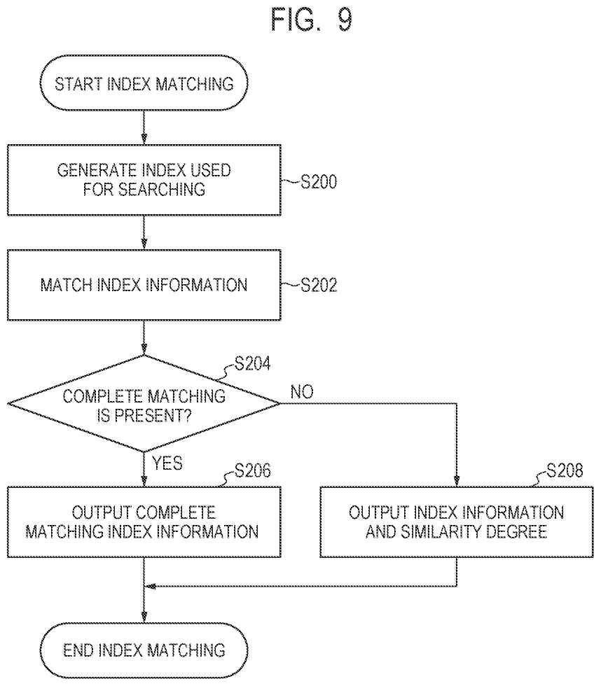

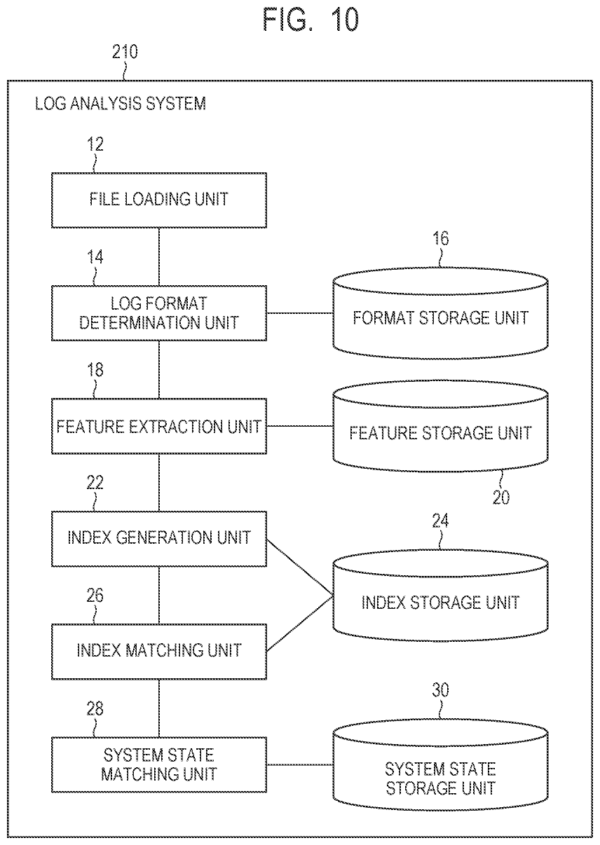

Next, the operation of the log analysis system 10 according to the present example embodiment will be further described with reference to FIG. 8 and FIG. 9. The operations of the log analysis system 10 according to the present example embodiment are roughly classified into two types of operations, namely, an operation related to generation of indexes and an operation related to matching of indexes.

First, the operation related to generation of indexes will be described with reference to FIG. 8. FIG. 8 is a flowchart illustrating an operation related to generation of indexes of the log analysis system 10 according to the present example embodiment.

As illustrated in FIG. 8, in the operation related to generation of indexes, first, the file loading unit 12 loads the log file and the numerical data file input from the system to be analyzed (step S100). The file loading unit 12 outputs and inputs the loaded log file to the log format determination unit 14. When the log file is output, the file loading unit 12 outputs the loaded log files for each row or the log messages on significant multiple rows as a set at any time. The file loading unit 12 further outputs and inputs the loaded numerical data file to the feature extraction unit 18.

Next, the log format determination unit 14 compares each log message forming the log file input from the file loading unit 12 with the known format information stored in the format storage unit 16 (step S102). In such a way, the log format determination unit 14 determines whether or not known format information that matches each log message is present (step S104).

If matched known format information is present (step S104, YES), the log format determination unit 14 provides, to the log message, an identification ID of the format information that matches a log message of interest (step S106).

On the other hand, if no matched known format information is present (step S104, NO), the log format determination unit 14 classifies the log message as a log message of an unknown format (step S108).

Every time step S106 or step S108 for each log message is completed, the log format determination unit 14 determines whether or not comparison of the input log file with the known format information is completed (step S110). If the comparison is not completed (step S110, NO), the log format determination unit 14 returns to the step S100 and repeats steps after step S100.

On the other hand, if the comparison is completed (step S110, YES), the log format determination unit 14 determines whether or not a log message classified as a log message of an unknown format is present (step S112). If no log message classified as an unknown format is present (step S112, NO), the log format determination unit 14 outputs a set of log messages for which the identification IDs are provided and inputs the set to the feature extraction unit (step S120).

If a log message classified as an unknown format is present (step S112, YES), the log format determination unit 14 extracts format information from the set of the log messages classified as the unknown format (step S114). For example, for extraction of the format information, an algorithm of known machine learning such as clustering or sequential pattern mining can be used. Further, when format information is extracted, the administrator or the user may provide, to the log format determination unit 14, arbitrary definition information related to a variable such as a user name or a machine name included in the log.

As an example, when log messages having a plurality of different formats are mixed together, the log format determination unit 14 can extract formats as follows. That is, first, the log format determination unit 14 classifies the log messages belonging to each format by clustering. Next, the log format determination unit 14 separates a character string that is common to each log message inside the classified cluster and variable character strings that differ between the log messages and thereby extracts the format.

Note that, in the case described above, if format determination of all the log messages is completed (step S110, YES), the log format determination unit 14 extracts a format from the set of the log messages of an unknown format (step S114). In addition, for example, in a case where the log messages are sequentially input or in a case where the log messages are loaded from a database, the log format determination unit 14 may regularly operate so as to extract a format from the set of the log messages of an unknown format. In such a case, the log format determination unit 14 can operate so as to extract a format from the set of the log messages based on an arbitrary time width or the number of log messages of an unknown format.

Next, the log format determination unit 14 provides an identification ID to the information on the extracted unknown format and causes the format storage unit 16 to store the information with the identification ID (step S116).

Next, the log format determination unit 14 provides an identification ID stored in the format storage unit 16 to each log message included in the set of the log messages of an unknown format (step S118). Next, the log format determination unit 14 outputs the set of the log messages to which the identification IDs described above are provided and inputs the set to the feature extraction unit 18 (step S120).

Next, the feature extraction unit 18 extracts a plurality of feature amounts from the set of the log messages having the identification IDs input from the log format determination unit 14 and the numerical data input from the file loading unit 12 (step S122). The feature extraction unit 18 has one or a plurality of algorithms such as a known numerical value statistic for modeling the input data or machine learning as a feature amount extraction rule.

The feature extraction unit 18 extracts one or a plurality of feature amounts from the set of the log messages having the input identification ID. The feature amount extracted from the log message may be, for example, a combination of the plurality of log messages having a different identification ID, the appearance order of the plurality of log messages having different identification IDs, periodicity of the log messages, or the like. Further, the feature amount may be, for example, an appearance frequency of variables that is included for each identification ID of the log message or an appearance frequency for each type or the like. Herein, the expression “identification IDs are different” means “log formats are different”, and the expression “for each identification ID” means “for each log format”.

For example, the feature extraction unit 18 aggregates appearance frequencies of log messages for each identification ID described above for each unit time. The feature extraction unit 18 can use the total value, the simple average value, the maximum value, the minimum value, the moving average value, or the like as the value of the appearance frequency. Further, the feature extraction unit 18 can apply an algorithm of frequent pattern mining such as the Apriori algorithm or a linear time closed itemset miner (LCM), for example to information on appearance frequency of log messages for each identification ID per the unit time. Thereby, the feature extraction unit 18 can find a combination of log messages formed of a plurality of log messages having the identification ID. The feature extraction unit 18 can further apply the algorithm of sequential pattern mining to the information on an appearance frequency of log messages for each identification ID per the unit time described above, for example. In such a way, the feature extraction unit 18 may find the output order of log messages formed of a plurality of log messages having the identification ID.

The feature extraction unit 18 further extracts one or a plurality of feature amounts from input numerical data. A feature amount extracted from numerical data may be, for example, a simple average value, the maximum value, the minimum value, a moving average value, a frequency, or the like per unit time.

Note that the feature extraction unit 18 may be any unit that extracts a plurality of feature amounts. For example, the feature extraction unit 18 may be a unit that extracts a plurality of feature amounts from a set of log messages or may be a unit that extracts a plurality of feature amounts from log messages and numerical data.

The feature extraction unit 18 extracts a feature amount of the log message and a feature amount of the numerical data every arbitrary unit time. For example, a feature amount is extracted every one minute.

Furthermore, the feature extraction unit 18 inputs a feature information including the extracted feature amount to the index generation unit 22. The feature extraction unit 18 further causes the feature storage unit 20 to store the feature information including the extracted feature amount for each feature amount.

FIG. 4 illustrates an example of the feature information including the feature amount extracted by the feature extraction unit 18. The feature amounts are output every unit time, and each feature amount is formed of a plurality of feature amounts. In the example illustrated in FIG. 4, as two types of feature amounts, an appearance frequency of the format 1001 that is feature amount 1 and an appearance frequency of a combination of the format 2001, the format 2002, and the format 2003 that are feature amount 2 are defined. The feature amounts 1 and 2 are output every unit time, that is, every one minute, respectively.

Note that, in the operations described above, while the feature extraction unit 18 extracts a feature amount at an arbitrary unit time, the example embodiment is not limited thereto. For example, the feature extraction unit 18 may output values aggregated at a plurality of time ranges such as one minute, ten minutes, or one hour, respectively.

Furthermore, the feature extraction unit 18 may directly extract and register data into which the numerical data is divided for each unit time as a feature amount for each unit time.

Next, the index generation unit 22 generates an index based on feature information including the feature amount extracted by the feature extraction unit 18 (step S124). As illustrated in FIG. 4 as an example, the feature amount for each unit time extracted by the feature extraction unit 18 includes a plurality of feature amounts that are different from each other. The index generation unit 22 generates an index by using the plurality of feature amounts.

For example, the index generation unit 22 can generate an index as follows. That is, the index generation unit 22 normalizes a value for each feature amount for all the sections of data of the input feature amounts. The index generation unit 22 generates the combination of the plurality of normalized feature amounts per unit time as an index. As an example of normalization, the index generation unit 22 can extract the maximum value of all the sections for each feature amount, that is, a variation range and use the value into which the value for each unit time is divided by the extracted maximum value as an index value. For example, in the example illustrated in FIG. 4, when the maximum value in all the sections of the feature amount 1 is “100”, the normalized value at a time “12:00:00” is “0.1”.

The index generation unit 22 may further use a neural network for generating an index. For example, as a neural network, a convolutional neural network (CNN), a recurrent neural network (RNN), an autoencoder, or the like can be used.

Furthermore, the index generation unit 22 can determine similarity between indexes generated as described above and exclude a duplicate index. At this time, the index generation unit 22 can provide the time information of the excluded index to the not-excluded index. For example, when a time “2017/09/26 11:30:00” and a time “2017/09/27 09:50:00” have exactly the same index “−1, 0.5,−0.2, 1”, the latter index information can be deleted, and the time information of the latter can be added to time information of the former.

Furthermore, the index generation unit 22 can convert the generated index into a binary code by using an arbitrary algorithm. The binary code is multi-digit codes expressed by a combination of “0” or “1”. For example, the index generation unit 22 can convert the index expressed as “−1, 0.5, −0.2, 1” into the binary code expressed as “0101”, for example, by using a conversion rule such as a signum function.

Further, in the example described above, while the number of digits in the index and the number of digits in the binary code are the same as each other, both the number of digits are not necessarily required to be the same. For example, when an index is converted into a binary code, the index generation unit 22 can express a symbol and a value separately. In such a case, the index generation unit 22 can separately express a symbol and a value to convert the index of “−1, 0.5, −0.2, 1” into a binary code such as “01110011”.

Further, as a constraint condition in conversion into a binary code, similarity between indexes that can be expressed by a distance function such as the Euclidean distance or the Manhattan distance may be used. For example, a case where there are three types of indexes of “−1, 0.5, −0.2, 1”, “−0.5, 1, 0.3, 1”, and “1, 0, 1, −1” is considered. The Euclidean distance between “−1, 0.5, —0.2, 1” and “−0.5, 1, 0.3, 1” is about 0.87. On the other hand, the Euclidean distance between “−1, 0.5, −0.2, 1” and “1, 0, 1, −1” is about 3.11. Thus, it can be determined that the latter combination has lower similarity between indexes than the former combination. The binary code can be defined such that the level of similarity of the binary code also depends on the level of similarity between indexes. At this time, the index generation unit 22 may convert an index into a binary code by using a neural network such as a CNN, an RNN, or an autoencoder.

Further, the index generation unit 22 may convert the index into a hash value by using a separately defined arbitrary hash function.

Further, the index generation unit 22 can employ various indicators as an indicator that converts the index, in addition to the binary code described above, as long as the indicator can uniquely identify the index. For example, the index generation unit 22 may employ a bitmap or the like as an indicator that converts the index.

Further, in the operations described above, while the index generation unit 22 directly generates an index from a combination of feature amounts per unit time output from the feature extraction unit 18, the example embodiment is not limited thereto. The index generation unit 22 may generate an index by using a value obtained by further performing a statistical process such as arithmetic operations, a process for obtaining an average, a process for obtaining the maximum, or a process for obtaining the minimum on the combination of the feature amounts per unit time. For example, the index generation unit 22 may generate an index by using a value obtained by further aggregating the feature amounts that is extracted every one minute by the feature extraction unit 18 as the average value for every ten minutes.

Next, the index generation unit 22 causes the index storage unit 24 to store the index information including the index generated as described above (step S126).

In such a way, the log analysis system 10 according to the present example embodiment ends the operation related to generation of indexes.

Next, an operation related to matching of indexes will be described with reference to FIG. 9. FIG. 9 is a flowchart illustrating an operation related to matching of indexes of the log analysis system 10 according to the present example embodiment.

In matching of indexes, a text and numerical data are newly input to the log analysis system 10 for search. The input text may be a text log or may be a text that may form the text log. Further, it is only necessary that a text or numerical data is input. Note that, since the operations up to generation of the index for search from the text and the numerical data newly input for search are the same as the operations described above, the description thereof is omitted.

First, the index generation unit 22 generates index information for search including an index for search based on the text and the numerical data newly input for search as described above (step S200). The index generation unit 22 inputs the generated index information for search to the index matching unit 26. Note that the index generation unit 22 can generate an index from the input data for each given unit time. The index generation unit 22 may further operate so as to generate an index for each arbitrary unit time input by the administrator and the user.

Next, the index matching unit 26 matches the index information for search input from the index generation unit 22 with known index information stored in the index storage unit 24 (step S202). In the matching, the index matching unit 26 can compare a simple index or a binary code or a hash into which the index is converted, for example. In such a way, the index matching unit 26 determines whether or not known index information that completely matches the index information for search is present (step S204).

If completely matched known index information is present (step S204, YES), the index matching unit 26 outputs the completely matched known index information as a matching result (step S206).

On the other hand, if no completely matched known index information is present (step S204, NO), the index matching unit 26 outputs, as a matching result, one or multiple pieces of known index information that are similar to the index information for search together with the similarity degree thereof (step S208). The index matching unit 26 can output only known index information in which the similarity degree calculated by using an arbitrary function exceeds a given threshold. The index matching unit 26 can calculate a similarity degree between the index information for search and the known index information by using a distance function such as the Euclidean distance or the Manhattan distance, for example.

Note that, when the index information is output, the index matching unit 26 may output similar known index information and the similarity degree thereof in descending order of the similarity degree. Further, the index matching unit 26 can also output the original text log and numerical data as reference information based on time information included in the completely matched known index information or the similar known index information. Further, the index matching unit 26 may output all the similar known index information and perform highlighting such as changing colors only on the known index information having a similarity degree that exceeds a threshold, for example.

In such a way, the log analysis system 10 according to the present example embodiment ends the operations related to matching of indexes.

As described above, the log analysis system 10 according to the present example embodiment models a log of an input text and input numerical data in a plurality of different points of view and generates an index obtained by integrating the modeled information. Accordingly, the log analysis system 10 according to the present example embodiment can identify a state of a system at any time based on the generated index in such a way.

Furthermore, the log analysis system 10 according to the present example embodiment can reduce and further minimize missing of information on a feature amount indicating a state of a system by using the previous index obtained by combining the models in multiple points of view or the raw numerical data. In the present example embodiment, the numerical data that is important in analysis of the state of a system can be handled together with a text log.

Further, even when the system has enormous text logs and numerical data, the log analysis system 10 according to the present example embodiment can perform high-speed and efficient identification of the system state by converting the index information into a binary code or a hash value.

In such a way, according to the present example embodiment, the feature amount indicating a state of a system can be generated from a text log and numerical data without providing information and configuration information related to the state of a target system in advance while reducing missing of information. Further, according to the present example embodiment, it is possible to generate information indicating a state of a system without requiring to manually define the state of the target system in advance. Furthermore, according to the present example embodiment, the state of the system can be identified by using the generated feature amount.

Note that the file loading unit 12, the log format determination unit 14, the format storage unit 16, the feature extraction unit 18, the feature storage unit 20, the index generation unit 22, the index storage unit 24, and the index matching unit 26 can start the operation at various timings. For example, each of the units can start the operation in response to reception of a log analysis start command provided by the administrator or the user from the input device (not illustrated), reception of a log analysis start command provided by another program or software, input or update of a log file, or the like. Note that a system state matching unit 28 and a system state storage unit 30 in the second example embodiment described later, a log comparison unit 32 in the third example embodiment, and a log conversion unit 34 in the fourth example embodiment can start the operation in the same manner.

### Second Example Embodiment

A log analysis system and a log analysis method according to a second example embodiment of the present invention will be described with reference to FIG. 10 to FIG. 12. Note that the same components as those in the log analysis system and a log analysis method according to the first example embodiment described above are labeled with the same references, and the description thereof will be omitted or simplified.

First, the configuration of the log analysis system according to the present example embodiment will be described with reference to FIG. 10. FIG. 10 is a block diagram illustrating a configuration of a log analysis system 210 according to the present example embodiment.

The basic configuration of the log analysis system 210 according to the present example embodiment is substantially the same as the configuration of the log analysis system 10 according to the first example embodiment. The log analysis system 210 according to the present example embodiment has a system state matching unit 28 and a system state storage unit 30 in addition to the configuration of the log analysis system 10 according to the first example embodiment.

The system state storage unit 30 stores the past system state and a time associated therewith in the system of interest. FIG. illustrates an example of the system state. As the system state, although not particularly limited, “switch failure” indicating a failure of a switch, “NW failure” indicating a failure of a network, “HDD failure” indicating a failure of a hard disk, or the like are stored, for example, as illustrated in FIG. 11.

The system state matching unit 28 searches for information of the system state storage unit 30 based on the time included in the past index information output as a result of matching performed by the index matching unit 26 described in the above first example embodiment. Furthermore, the system state matching unit 28 outputs a system state associated with the time stored in the system state storage unit 30 as a result of searching for information.

Note that the log analysis system 210 according to the present example embodiment can take the hardware configuration illustrated in FIG. 7 in the same manner as the log analysis system 10 according to the first example embodiment. In such a case, the CPU 102 executes a program stored in the storage device 106 and thereby also functions as the system state matching unit 28 illustrated in FIG. 10. Further, the storage device 106 also functions as the system state storage unit 30 illustrated in FIG. 10.

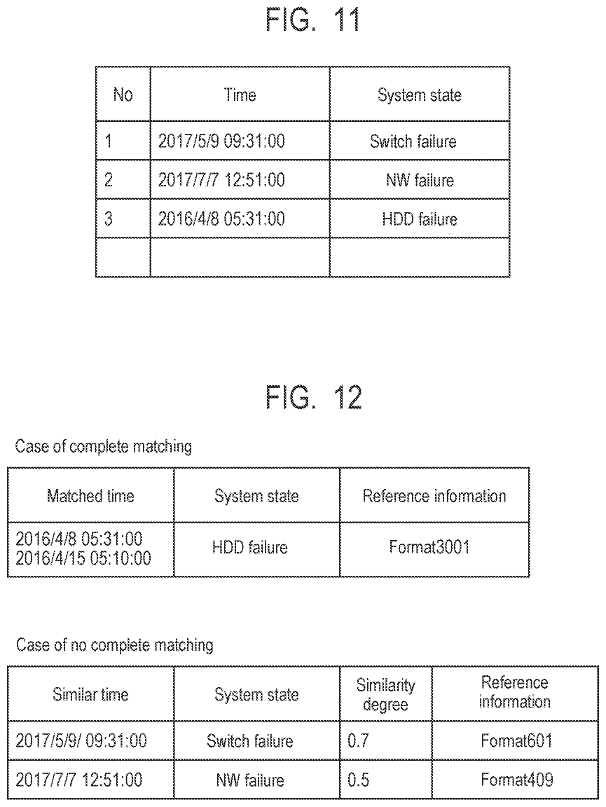

Next, the operation of the log analysis system 210 according to the present example embodiment will be further described with reference to FIG. 12. FIG. 12 is a diagram illustrating an example of output of the log analysis system according to the present example embodiment. Note that, since the operation up to the index matching unit 26 is the same as the operation of the corresponding component in the log analysis system 10 according to the first example embodiment, the description thereof will be omitted.

The system state matching unit 28 searches the system state storage unit 30 based on a matching result output from the index matching unit 26 and outputs a system state which matches the matching result. For example, when known index information including “2017/08/30 13:45:00” as a time is obtained as a matching result from the index matching unit 26, the system state matching unit 28 uses the time as a key to search the system state storage unit 30. When a system state including the time is stored in the system state storage unit 30, the system state matching unit 28 outputs the system state.

On the other hand, when no system state including the time is stored in the system state storage unit 30, the system state matching unit 28 outputs a matching result indicating that no matching past system state is present.

Further, the index matching unit 26 may output multiple pieces of known index information together with a similarity degree. In such a case, the system state matching unit 28 searches for whether or not a system state matching each piece of information is present. Furthermore, based on the similarity degree, the system state matching unit 28 rearranges and outputs matching results.

FIG. 12 illustrates an example of output of the system state matching unit 28. In the case illustrated in FIG. 12, information on a failure that occurred in the past in the system is registered as a system state. Note that these system states are mere examples, and any state may be a system state as long as it is a state that can be defined by a combination of any text log message and numerical data. The system state may be, for example, a user's action such as a change in a movement state such as walking, sitting down, or the like or an operation on a physical system performed by a worker in a factory and the influence thereof. Further, the system state may be, for example, a labor productivity or a mental state, such as work efficiency or a concentration level of an employee. Furthermore, the system state may be, for example, an outcome of contract by a salesperson, an operation of a company, or a financial state of a company.

As described above, in the log analysis system 210 according to the present example embodiment, the index matching unit 26 outputs time information that is in a state that matches or is similar to input data. Further, the system state matching unit 28 searches for a system state stored in the system state storage unit 30 based on the output time information and outputs a matched system state.

In such a way, according to the present example embodiment, it is possible to output the past system state associated with an input text log and numerical data without requiring the user to define a rule related a text log and numerical data related to a particular system state.

### Third Example Embodiment

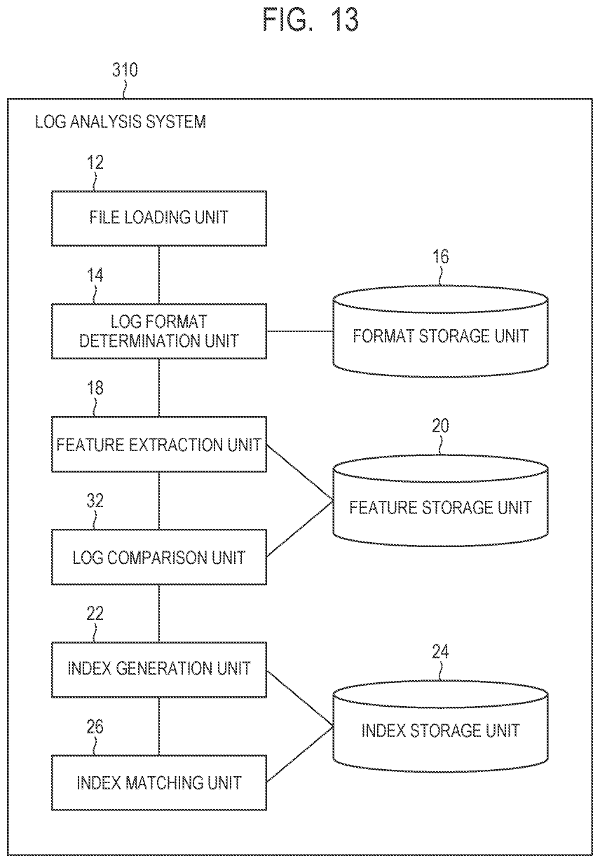

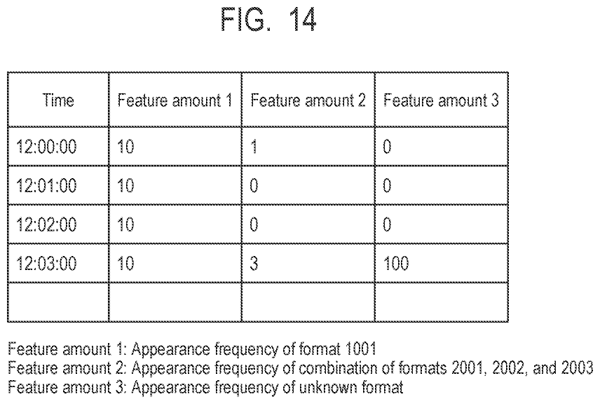

A log analysis system and a log analysis method according to a third example embodiment of the present invention will be described with reference to FIG. 13 and FIG. 14. Note that the same components as those in the log analysis system and a log analysis method according to the first and second example embodiments described above are labeled with the same references, and the description thereof will be omitted or simplified.

First, the configuration of the log analysis system according to the present example embodiment will be described with reference to FIG. 13. FIG. 13 is a block diagram illustrating a configuration of a log analysis system 310 according to the present example embodiment.

The basic configuration of the log analysis system 310 according to the present example embodiment is substantially the same as the configuration of the log analysis system 10 according to the first example embodiment. The log analysis system 310 according to the present example embodiment has a log comparison unit 32 in addition to the configuration of the log analysis system 10 according to the first example embodiment.

The log comparison unit 32 extracts, as difference information, a difference between a feature amount of the past log message extracted by the feature extraction unit 18 and a feature amount of a log message included in data newly input to the log analysis system 310. That is, the log comparison unit 32 extracts, as difference information, a difference between a feature amount at a first time of a log message and a feature amount at a second time that is different from the first time.

Note that the log analysis system 310 according to the present example embodiment can take the hardware configuration illustrated in FIG. 7 in the same manner as the log analysis system 10 according to the first example embodiment. In such a case, the CPU 102 executes a program stored in the storage device 106 and thereby also functions as the log comparison unit 32 illustrated in FIG. 13.

Next, the operation of the log analysis system 310 according to the present example embodiment will be further described with reference to FIG. 14. FIG. 14 is a diagram illustrating an example of feature information extracted by the log analysis system according to the present example embodiment. Note that only the difference from the operation of the log analysis system 10 according to the first example embodiment will be described below.

The log comparison unit 32 compares a feature amount of a log message included in data newly input to the log analysis system 310 with a feature amount of the past log message stored in the feature storage unit 20 and extracts the difference between both the feature amounts as difference information.

For example, the log comparison unit 32 can compares an appearance frequency of log messages on an identification ID basis as feature amounts of log messages. In such a case, the log comparison unit 32 can extract, as difference information, a time or a value that is out of a range calculated from the maximum value or the minimum value of the past appearance frequencies or the standard deviation thereof.

Further, for example, the log comparison unit 32 can compare, as feature amounts of log messages, the output order of log messages formed of a plurality of log messages having an identification ID. In such a case, the log comparison unit 32 can extract, as difference information, the number of combinations of log messages which do not match the past output order and a time range including the series of log messages.

Further, for example, the log comparison unit 32 can compare logs output within any time range with a format stored in the format storage unit 16 as feature amounts of log messages. In such a case, the log comparison unit 32 can extract, as difference information, the number of log messages which do not match the format and the time range including the log messages which do not match the format. Further, the user may arbitrarily define so as to divide a time range with a fixed width.

Furthermore, the log comparison unit 32 adds the extracted difference information to feature information output by the feature extraction unit 18 and inputs the added information in the index generation unit 22. FIG. 14 illustrates an example of feature information output from the feature extraction unit 18 and the log comparison unit 32.

The index generation unit 22 generates an index by combining difference information input from the log comparison unit 32 in addition to feature information input from the feature extraction unit 18 according to the first example embodiment. The index generation unit 22 can handle difference information as one feature amount and generate an index in the same manner as described above.

For example, as illustrated in FIG. 14, the index generation unit 22 can generate an index by combining the feature amount 1 that means the appearance frequency of the format 1001 input from the feature extraction unit 18 according to the first example embodiment, and the feature amount 2 that means the appearance frequency of the combination of the formats 2001, 2002, and 2003 input from the feature extraction unit 18 according to the first example embodiment, and a feature amount 3 corresponding to difference information on the number of log messages which do not match a format input from the log comparison unit 32 and a time range including the log messages.

The log analysis system 310 according to the present example embodiment regards the feature information on logs stored in the feature storage unit 20 as behavior in the steady state of the system and adds a difference therefrom to the feature of logs and the index as another factor. Accordingly, the log analysis system 310 according to the present example embodiment can generate and compare indexes including two factors of a steady state and a non-steady state.

As described above, according to the present example embodiment, it is possible to create and search a database in a system state taking non-steady behavior and steady behavior of a system into consideration without requiring the user to define a steady state of the system.

### Fourth Example Embodiment

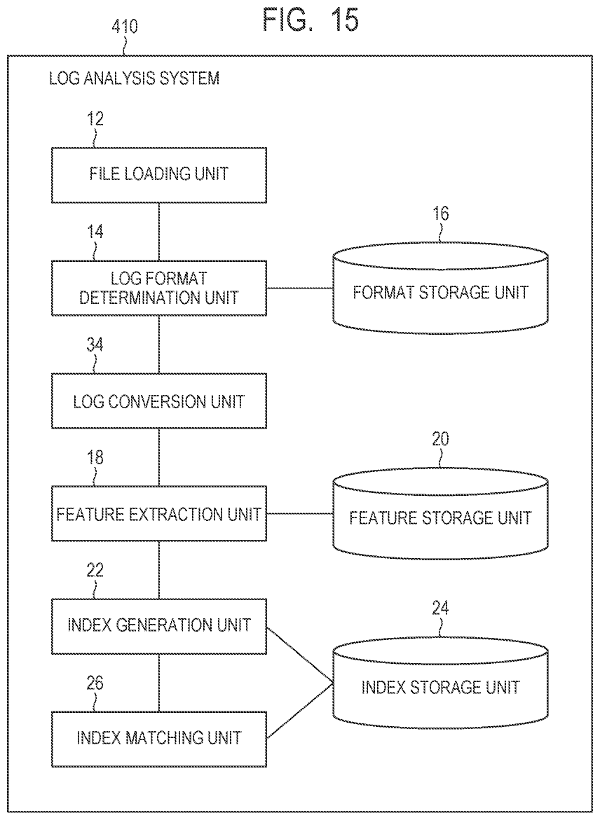

A log analysis system and a log analysis method according to a fourth example embodiment of the present invention will be described with reference to FIG. 15. Note that the same components as those in the log analysis system and a log analysis method according to the first to third example embodiments described above are labeled with the same references, and the description thereof will be omitted or simplified.

First, the configuration of the log analysis system according to the present example embodiment will be described with reference to FIG. 15. FIG. 15 is a block diagram illustrating a configuration of a log analysis system 410 according to the present example embodiment.

The basic configuration of the log analysis system 410 according to the present example embodiment is substantially the same as the configuration of the log analysis system 10 according to the first example embodiment. The log analysis system 410 according to the present example embodiment has a log conversion unit 34 in addition to the configuration of the log analysis system 10 according to the first example embodiment.

The log conversion unit 34 generates a time-series distribution of the frequency for each identification ID based on a determination result of a log format from the log format determination unit 14. Further, the log conversion unit 34 generates a time-series distribution of the frequency for each feature amount extracted by the feature extraction unit 18.

Note that the log analysis system 410 according to the present example embodiment can take the hardware configuration illustrated in FIG. 7 in the same manner as the log analysis system 10 according to the first example embodiment. In such a case, the CPU 102 executes a program stored in the storage device 106 and thereby also functions as the log conversion unit 34 illustrated in FIG. 15.

Next, the operation of the log analysis system 410 according to the present example embodiment will be described. Note that only the difference from the operation of the log analysis system 10 according to the first example embodiment will be described below.

The log conversion unit 34 converts input data into a time-series distribution of numerical values. More specifically, a set of log messages provided with the identification ID from the log format determination unit 14 is input to the log conversion unit 34, for example. The log conversion unit 34 performs conversion into frequency time-series information for each identification ID based on the input set of log messages provided with the identification ID.

For example, in a case of conversion into numerical time-series information on a one-minute basis, when 20 log messages of the identification ID of “1” were output from “2017/09/26 11:00:00” to “2017/09/26 11:00:59”, the frequency at the time “2017/09/26 11:00:00” is “20”.

Further, the log conversion unit 34 similarly converts a distribution of feature amounts output from the feature extraction unit 18. For example, when 10 sets of log messages of the output order “1, 2, 3” of the identification ID were present from “2017/09/26 11:00:00” to “2017/09/26 11:00:59”, the frequency at the time “2017/09/26 11:00:00” is “10”. Further, when a set of log messages extends over two times, a frequency may be added to the time including the last log message of the series of log messages.

The log conversion unit 34 outputs frequency time-series information obtained by aggregating frequencies on a given unit basis as described above and inputs the time-series information to the feature extraction unit 18.

The feature extraction unit 18 extracts, as a feature amount of a log, a correlation relationship between pieces of frequency numerical time-series information or between frequency numerical time-series information and numerical data input from the log conversion unit 34 in addition to the feature amount in the first example embodiment. In extraction of a correlation relationship, the feature extraction unit 18 can use a known algorithm to extract a correlation relationship, such as Auto-Regressive eXogenous (ARX) model, rule mining, or the like, for example.

As with the present example embodiment, a feature amount for generating an index can be extracted by further using frequency time-series information.

### Another Example Embodiment

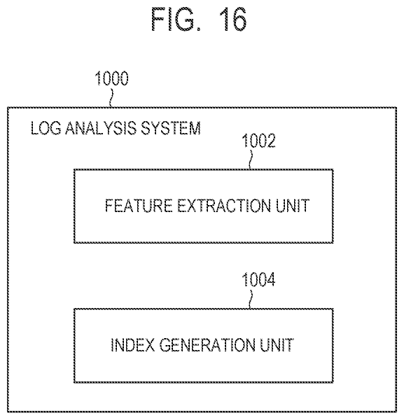

The log analysis system described in the above example embodiment can be configured as illustrated in FIG. 16 according to another example embodiment. FIG. 16 is a block diagram illustrating a configuration of a log analysis system according to another example embodiment.

As illustrated in FIG. 16, a log analysis system 1000 according to another example embodiment has a feature extraction unit 1002 and an index generation unit 1004. The feature extraction unit 1002 extracts at least one feature of a text log file including a plurality of text log messages corresponding to information in which an event in a target system and a time when the event occurred are associated with each other. The index generation unit 1004 generates an index indicating a state of the target system based on the feature and numerical data including numerical information related to the target system and a time when the numerical information was stored.

According to the log analysis system 1000 according to another example embodiment, an index indicating a state of a target system is generated based on a feature and numerical data of a text log file. Thus, according to another example embodiment, it is possible to generate information indicating a state of a system without requiring to manually define a state of the target system in advance.

### Modified Example Embodiments

The present invention is not limited to the example embodiments described above, and various modifications are possible.

For example, respective example embodiments described above may be implemented in combination as appropriate. Further, the present invention is not limited to respective example embodiments described above and can be implemented in various forms.

Further, the scope of each of the example embodiments further includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disc-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

Further, division of blocks illustrated in each block diagram indicates a configuration represented for the purpose of illustration. The present invention described with an example of each example embodiment is not limited to the configuration illustrated in each block diagram in the implementation thereof.

Although forms for implementing the present invention have been described above, the example embodiments described above are for easier understanding of the present invention and are not for limited interpretation of the present invention. The present invention may be changed or improved without departing from the spirit thereof, and the equivalent thereof is also included in the present invention.

The whole or part of the example embodiments disclosed above can be described as, but not limited to, the following supplementary notes.

### (Supplementary Note 1)

A log analysis system comprising:

a feature extraction unit that extracts at least one feature of a text log file including a plurality of text log messages corresponding to information in which an event in a target system and a time when the event occurred are associated with each other; and

an index generation unit that, based on the feature and numerical data including numerical information related to the target system and a time when the numerical information was stored, generates an index indicating a state of the target system.

### (Supplementary Note 2)

The log analysis system according to supplementary note 1,

wherein the feature extraction unit extracts features of the plurality of text log messages that are independent of each other, and

wherein the feature extraction unit extracts the feature related to variation in the text log messages in an arbitrary time unit and outputs information in which a plurality of the features in the time unit are combined.

### (Supplementary Note 3)

The log analysis system according to supplementary note 2, wherein the index generation unit extracts a variation range from each of the features and normalizes a value for each time based on the variation range.

### (Supplementary Note 4)

The log analysis system according to any one of supplementary notes 1 to 3, wherein the feature extraction unit extracts, as the feature of the text log messages, at least any of a frequency for each form of the text log messages, a combination of the plurality of text log messages having different forms, appearance order of the plurality of text log messages having different forms, periodicity of the text log messages, and a type-basis appearance frequency of a variable included for each form of the text log messages.

### (Supplementary Note 5)

The log analysis system according to any one of supplementary notes 1 to 4, wherein the index generation unit converts the index into an indicator configured to uniquely identify the index.

### (Supplementary Note 6)

The log analysis system according to any one of supplementary notes 1 to 5, wherein the index generation unit converts the index into the indicator based on similarity between indexes expressed by a distance function.

### (Supplementary Note 7)

The log analysis system according to any one of supplementary notes 1 to 6 further comprising:

an index storage unit that stores the index that is known; and

an index matching unit that matches the index used for search generated based on a newly input text or numerical data with the known index and outputs a matching result.

### (Supplementary Note 8)

The log analysis system according to supplementary note 7 further comprising a system state matching unit that outputs a system state of the target system based on the matching result from the index matching unit.

### (Supplementary Note 9)

The log analysis system according to any one of supplementary notes 1 to 8 further comprising a log comparison unit that extracts a difference between a feature amount at a first time of a log message and a feature amount of a log message at a second time that is different from the first time,

wherein the index generation unit generates the index by further using the difference.

### (Supplementary Note 10)

The log analysis system according to any one of supplementary notes 1 to 9 further comprising a log conversion unit that converts a set of the text log messages for each form into frequency time-series information,

wherein the feature extraction unit extracts, as the feature, a correlation relationship between pieces of the frequency time-series information or between the frequency time-series information and the numerical data.

### (Supplementary Note 11)

A log analysis method comprising:

extracting at least one feature of a text log file including a plurality of text log messages corresponding to information in which an event in a target system and a time when the event occurred are associated with each other; and

based on the feature and numerical data including numerical information related to the target system and a time when the numerical information was stored, generating an index indicating a state of the target system.

### (Supplementary Note 12)

A storage medium storing a program that causes a computer to perform:

extracting at least one feature of a text log file including a plurality of text log messages corresponding to information in which an event in a target system and a time when the event occurred are associated with each other; and

based on the feature and numerical data including numerical information related to the target system and a time when the numerical information was stored, generating an index indicating a state of the target system.

### REFERENCE SIGNS LIST

10, 210, 310, 410, 1000 log analysis system
12 file loading unit
14 log format determination unit
16 format storage unit
18 feature extraction unit
20 feature storage unit
22 index generation unit
24 index storage unit
26 index matching unit
28 system state matching unit
30 system state storage unit
32 log comparison unit
34 log conversion unit
102 CPU
104 memory
106 storage device
108 communication interface
1002 feature extraction unit
1004 index generation unit

What is claimed is:

1. A log analysis system comprising:
a feature extraction unit that extracts at least one feature of a text log file including a plurality of text log messages corresponding to information in which an event in a target system and a time when the event occurred are associated with each other; and
an index generation unit that, based on the feature and numerical data including numerical information related to the target system and a time when the numerical information was stored, generates an index indicating a state of the target system.

2. The log analysis system according to claim 1,
wherein the feature extraction unit extracts features of the plurality of text log messages that are independent of each other, and
wherein the feature extraction unit extracts the feature related to variation in the text log messages in an arbitrary time unit and outputs information in which a plurality of the features in the time unit are combined.

3. The log analysis system according to claim 2, wherein the index generation unit extracts a variation range from each of the features and normalizes a value for each time based on the variation range.

4. The log analysis system according to claim 1, wherein the feature extraction unit extracts, as the feature of the text log messages, at least any of a frequency for each form of the text log messages, a combination of the plurality of text log messages having different forms, appearance order of the plurality of text log messages having different forms, periodicity of the text log messages, and a type-basis appearance frequency of a variable included for each form of the text log messages.

5. The log analysis system according to claim 1, wherein the index generation unit converts the index into an indicator configured to uniquely identify the index.

6. The log analysis system according to claim 1, wherein the index generation unit converts the index into the indicator based on similarity between indexes expressed by a distance function.

7. The log analysis system according to claim 1 further comprising:
an index storage unit that stores the index that is known; and
an index matching unit that matches the index used for search generated based on a newly input text or numerical data with the known index and outputs a matching result.

8. The log analysis system according to claim 7 further comprising a system state matching unit that outputs a system state of the target system based on the matching result from the index matching unit.

9. The log analysis system according to claim 1 further comprising a log comparison unit that extracts a difference between a feature amount at a first time of a log message and a feature amount of a log message at a second time that is different from the first time,
wherein the index generation unit generates the index by further using the difference.

10. The log analysis system according to claim 1 further comprising a log conversion unit that converts a set of the text log messages for each form into frequency time-series information,
wherein the feature extraction unit extracts, as the feature, a correlation relationship between pieces of the frequency time-series information or between the frequency time-series information and the numerical data.

11. A log analysis method comprising:
extracting at least one feature of a text log file including a plurality of text log messages corresponding to information in which an event in a target system and a time when the event occurred are associated with each other; and
based on the feature and numerical data including numerical information related to the target system and a time when the numerical information was stored, generating an index indicating a state of the target system.

12. A non-transitory storage medium storing a program that causes a computer to perform:
extracting at least one feature of a text log file including a plurality of text log messages corresponding to information in which an event in a target system and a time when the event occurred are associated with each other; and
based on the feature and numerical data including numerical information related to the target system and a time when the numerical information was stored, generating an index indicating a state of the target system.
